(19) United States
(12) Patent Application Publication
(10) Pub. No.: US 2006/0150320 A1
(43) Pub. Date: Jul. 13, 2006

(54) System for handling a person and method therefor

(76) Inventor: Asger Gramkow, Augustenborg (DK)

Correspondence Address: CANTOR COLBURN, LLP, 55 GRIFFIN ROAD SOUTH, BLOOMFIELD, CT, 06002, US

(21) Appl. No.: 10/541,954

(22) PCT Filed: Jan. 15, 2004
(86) PCT No.: PCT/DK04/00015

§ 371 Date: Jul. 8, 2005

(30) Foreign Application Priority Data
Jan. 15, 2003 (DK) PA 2003 00030

(51) Int. Cl. A61G 7/14; A61G 7/10

(52) U.S. Cl. 5/81.1 R; 5/86.1; 5/89.1

(57) ABSTRACT

The invention relates to a method of handling a person, such as lifting or moving the person from a first position to another, with a handling system including one or more support sheets initially positioned under the person. The method comprising the following steps: winding the one or more support sheets on at least two rollers to a position in close proximity of the person's body, positioning one or more frames above said person and said at least two rollers, connection said one or more frames to said at least two rollers, and handling the person by performing a lift in at least one of said one or more frames. The invention also relates to a handling system for lifting or moving a person from a first position to another.

### BACKGROUND OF THE INVENTION

The present invention relates to a method of handling a person, such as lifting or moving the person from a first position to another, with a handling system and a handling system according to the preamble of claim 16.

The available systems for lifting disabled persons usually incorporate the use of a sling. The sling is suspended in a lifting arm of the system with at least four wires positioned in the corners of the sling sheet. The sling sheet forms a support, which the person is positioned in during the lifting.

The sling lift systems have the significant disadvantage of supplying poor and incorrect support for the person being lifted. Especially persons needing back or neck support will have problems being lifted with a sling lift system.

Further, the systems have the disadvantage of supporting the person in a rather baggy manner, which requires that the lifted person remains still or at least very careful when moving. If the person does not move carefully there is the risk of the person falling out of the sling or the lift tipping over.

The lift system with a sling requires that the lift is operated with the person being in a horizontal or semi horizontal position. This is seen as an undignified and insecure position by the lifted person and thus often affects the self-awareness of the person as well as the attitude towards being lifted.

Even further, the sling system often requires an assisting person, such as a nurse or a social worker, on each side of a bed in order to position the sling underneath the bedridden person. Rolling and moving the person from one bedside to another by the assistants allows the sling to be moved underneath the bedridden person.

Examples of sling lift systems are known from e.g. GB patent application no. GB-A 2 248 817 and European patent application no. EP-A2 0 931 533.

Another example of the prior art is known from International Patent Application No. WO-A 84/02074. The support system includes a frame with a number of frame arms being positioned under the person's seat and armpits as well as behind the back.

By using the system it is possible to move a person from one chair to another in which the person is in a sitting position during the movement.

The system has the significant disadvantage of requiring that the disabled person can position himself in the system. Alternatively, an assisting person can position the frame arms underneath the seat and behind the back of the person when the person is in a chair or placed in a sitting position by the assistant.

The well-known systems all require a significant amount of body control from the person to be moved. If the person does not have this ability, the assistants have to use a significant amount of force in order to prepare the movement. The need for using force in often awkward positions means that the assistant has the risk of getting (industrial) injuries to especially the arms and back. Alternatively, the assistant will have to call in further help in order to complete the movement of the person.

An object of the invention is to create a method of lifting a person and a handling system that avoids the above-mentioned disadvantages.

Especially, it is an object to create a method of handling a person and a handling system that requires no physical force from an assistant in preparation of the handling and during the handling.

Further, it is an object to create a method of handling a person and a handling system that is agreeable and dignifying for the person being e.g. lifted or moved.

### SUMMARY OF THE INVENTION

The invention relates to a method of handling a person, such as lifting or moving the person from a first position to another, e.g. from a bed or a chair, with a handling system including support means with at least two support sheets initially positioned under the person, said method comprising the following steps:

winding said at least two support sheets on at least four rollers to a position in proximity of the person's body, connecting said at least four rollers to handling means, and handling the person by performing a lift or movement in said support means by said handling means.

Hereby, it is possible to perform a lift of a person in a manner that differs from the well-known person lift systems and without the disadvantages of these systems.

In an aspect of the invention, said connecting includes a locking or fixing process of said at least four rollers to one or more frames and connecting said handling means to one or more of said frames.

In a further aspect, said handling is performed as a vertical up or down movement or a horizontal movement e.g. of said lift yoke by said handling means.

In another aspect, said one or more support sheets, in a non-use situation, are suspended and stretched out by said at least four rollers connected to holding means e.g. connected to the sides of a bed. Hereby, it is possible to use the bed in a normal way without being disturbed by the sheets when the handling system is not in use, especially if the sheets are in a breathable material.

In another aspect, handling is performed with only said upper support sheet and corresponding frame. Hereby, it is possible for the person in the up-right standing position to walk and at the same time being supported by the lift. Further, the person may push or drag the lift with him without aid from an assistant.

In an aspect, the mutual distance between said at least two support sheets are controlled and/or upheld. Hereby, it is ensured that the person may not slide out of the support sheets.

In an even further aspect, said at least two support sheets are moved sideways underneath the person by dragging at one edge of each sheet and releasing at the other edge of each sheet. Hereby, it is possible to control the person's movement in an advantageous way. Especially the pull and hold, respectively, allow very precise and small movements of the person.

The invention also relates to a handling system in which said support means includes at least two support sheets in contact with different areas of the person's body during handling, said support means further comprises at least four rollers for winding said at least two support sheets from opposite sides of the sheet to a position in close proximity of the person's body, said at least four rollers, and said support means being connected to said handling means through said rollers, wherein said support means establishes a handling structure around the person allowing the person to be lifted or moved by activating said handling means.

Hereby, it is possible to perform a lift of a person in a manner that differs from the well-known person lift systems and without the disadvantages of these systems. Especially it is possible to handle the person with little use of physical force from an assistant, as the assistant does not need to move the person in the preparing of lifting and during the lifting.

When the assistant does not need to use physical force in preparing and performing the lifting it is possible, in a higher degree, to focus on the well being of the person being lifted instead of the lift and the lift process. Further, the lift process will be more acceptable to the person being lifted on a mental level.

Even further, it is possible to perform the lifting of person in a manner, which advantageously supports different parts of the person's body e.g. the neck and head.

Also the holding of the person from the front by frames and support from the back with sheets are advantageous as the person may feel a higher degree of safety not being able to fall or slide out of the holding device—in a forward or backward direction.

Further, the rollers make the handling system more rigid and thus allow a support of the person that is more stable and reliable. This also makes it more comfortable and trustworthy for the person in the device.

As the rollers are covered by the sheet material they will not make the device less comfortable compared with the prior art. At the same time the rollers are positioned along parts of the person's body that usually are well-padded, such as the thighs and the sides of the back, and thus less sensitive to any load from the rollers.

With the present method and handling system it is also possible to handle persons with fewer assistants due to the fact that the handling does not require physical strength of the assistants. This is especially advantageous as jobs within the healthcare sector involving handling of persons, such as nurse or social worker, are seen as jobs with a lower status and thus harder to fill with qualified people.

It should be emphasised that with the phrase “from a first position to another” may be understood as moving the person a distance or rotating the person in the same position allowing a different part of the person to face the position.

It should be emphasised that with the term “sheet” is meant a broad, relatively thin, layer, sail or covering of material such as material of linen, cotton, nylon, leather, plastic, rubber or combinations hereof. Usually, the sheet is in a material used as an article of bedding. It is preferred that the sheet is in a breathable or semi-breathable material in order to enhance the person's comfort when being in contact with the material over a longer time period.

It should be emphasised that with the term “support” is meant an arrangement that supports, carries and/or upholds a person.

It should be emphasised that with the term “roller” is meant a hollow or solid elongated means to wind a sheet on.

In an aspect of the invention, said at least two support sheets include an upper support sheet and a lower support sheet, positioned under the upper and/or lower part of the person's body, respectively, e.g. under the back and head and under the seat or thighs of the person. Hereby, it is possible to create an advantageous handling system with a number of preferred functionalities.

In an aspect of the invention, said system further comprises one or more frames sections such as a lifting frame or a first frame section connected to said upper support sheet through said at least two rollers and/or a support frame or a second frame section connected to the lower support sheet through at least two rollers. Hereby, it is possible to create a handling system that handles a person in a gentle and dignifying manner e.g. by lifting the person in a system with a shape similar to an instructor chair.

In a further aspect, said lifting and support frames are connected by one or more straps e.g. straps from said lifting frame to each of said first and second frame part. Hereby, it is the relation between the frames maintained during lifting or moving of the person.

In an aspect of the invention, said first position is a bed including said at least one support sheet and at least two holding devices for said at least four rollers and said another position is a chair or similar means used in a sitting position, or vice versa. Hereby, it is possible to establish a system that is advantageous in daily use when lifting or moving a person. Further, the system may be a part of a standard bed such as a hospital bed without reducing the functionality of the bed.

In an aspect of the invention, said at least two holding devices is positioned on one or more movable guide rails e.g. on the sides of a bed. Hereby, it is possible to adapt the bed to a given situation such as a high position when rotating or moving the person sideways and a low position under normal or lifting situations.

In an aspect of the invention, said guide rails comprises drive means, such as electric motors, connected to said at least four rollers allowing the rollers to rotate clockwise or anticlockwise. Hereby, it is possible to control the person's movement in an advantageous way. Especially if the motors pull and hold, respectively, in the rollers allowing very precise and small movements of the person.

In an aspect of the invention, said at least four rollers are connected to handles through gear means e.g. with teethed wheels allowing a transmission. The handles may hereby be operated with less use of force.

In an aspect of the invention, said gear means include at least one spring operated locking pin and at least one ratchet wheel allowing pivotal movement in only one direction during the winding of said at least two support sheets on said at least four rollers. Hereby, advantageous features have been achieved in relation to the invention, as the sheets cannot unwind the rollers unintentionally.

In an aspect of the invention, said lifting frame or said first frame section comprise triangular or similarly shaped frame parts with ends connected to two of said at least four rollers. Further, two of said at least four rollers are connected between ends at said pivot hinge and at a boom as a frame part. Hereby, is a rigid handling frame advantageously established.

In an aspect of the invention, said rollers are connected through poles fixed to said frame parts, said rollers rotating on said poles with bearing means. Hereby, it is possible to transfer the weight of the person being lifted from the rollers to the rest of the frames in an advantageously manner with no risk of collapse in the frame connections.

In an aspect of the invention, the system comprises rear and front lifting lines connected to the yoke and extremity points of said one or more frame sections. Hereby, it is possible to create a stabile handling system that the person being handled will feel safe in.

In an aspect of the invention, said support means comprises adjustment means to adapt the size of the means to the body of the person in the area of the support sheets e.g. by changing the width of the frames. Hereby, it is possible to establish a controllable connection between the frame parts allowing the frames to be adapted to persons of different shapes.

### THE FIGURES

The invention will be described in the following with reference to the figures, in which

FIG. 1 illustrates an initial position in the process of lifting a person from a bed with a lift system according to the invention,

FIG. 2 illustrates the first step in the lifting process in which an upper support sheet is positioned next to the person,

FIG. 3 illustrates a further step in which a lifting frame is positioned above the torso of the person,

FIG. 4 illustrates the step of lifting the person to an up-right sitting position,

FIG. 5 illustrates the step of arranging a support frame and a lower support sheet under the seat of the person,

FIG. 6 illustrates the step of lifting the person in the lift system,

FIG. 7 illustrates a preferred embodiment of the lifting frame used in connection with the handling system,

FIG. 8 illustrates a further preferred embodiment of the lifting frame used in connection with the handling system,

FIG. 9 illustrates an embodiment of a flexible intersection in a lifting or support frame,

FIG. 10a and 10b illustrate different embodiments of frame locking systems,

FIGS. 11a and 11b illustrate the method of locking a roller to a frame with the use of a locking system,

FIGS. 12a and 12b illustrate preferred embodiments of the roller and frame endings,

FIG. 13 illustrates an embodiment of the support sheets,

FIG. 14 illustrates an initial position in the process of lifting a person from a bed with a lift system according to the invention,

FIGS. 15 to 19 illustrate the steps in the process of lifting the person from the bed, and

FIG. 20 illustrates a further embodiment of the invention.

### DETAILED DESCRIPTION

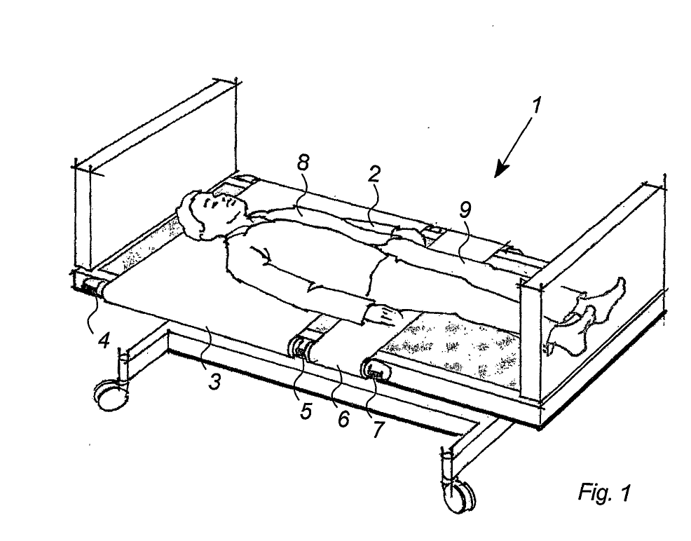

FIG. 1 illustrates an initial position in the process of lifting a person 2 from a bed 1 with a handling system according to the invention.

The handling system includes an upper support sheet 3, which is positioned on the bed mattress under the upper part of the person's body 8. Preferably, the sheet is positioned above the person's waistline such as under the back and head.

The upper support sheet 3 is winded up and stretched out by two rollers at each side of the bed. Each of the rollers is secured to the side of the bed by an upper and central holding device 4, 5 holding the ends of the roller.

In a similar manner, a lower support sheet 6 is winded up and stretched out by two rollers at each side of the bed. The central holding device 5 and a lower holding device 7 holding the ends of the roller secure each of the rollers to the side of the bed.

The lower support sheet 6 is also positioned on the bed mattress but under the lower part of the person's body 9. Preferably, the sheet is positioned below the person's waistline such as under the person's seat or thighs.

In the figure, the sheets are illustrated as standard bed sheets which do not affect the person during normal use of the bed.

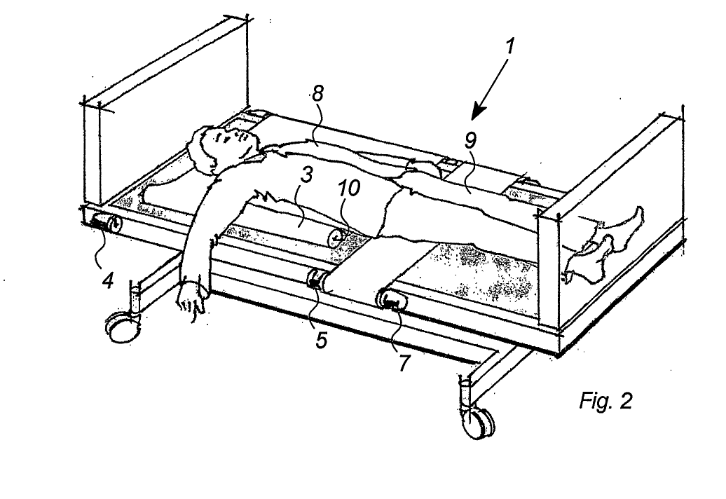

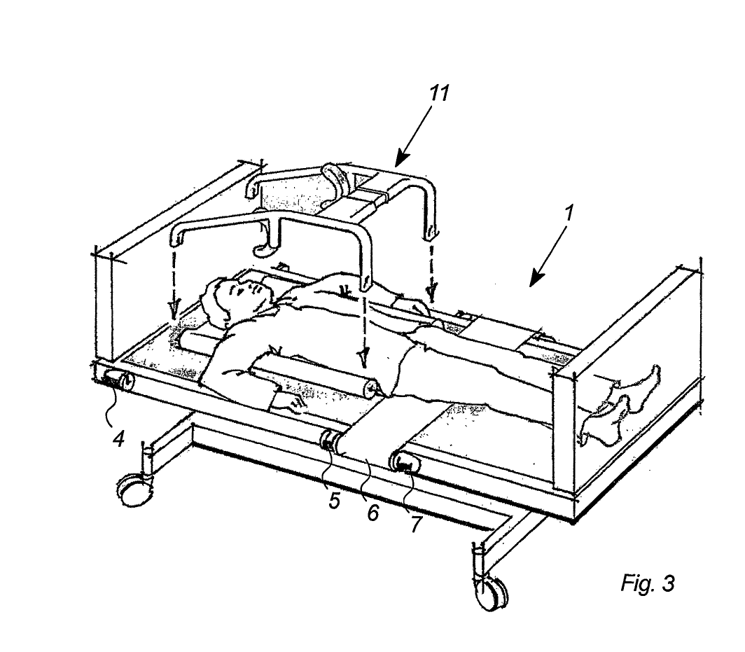

FIG. 2 illustrates the first step in the lifting process in which an upper support sheet 3 is positioned next to the person. The support sheet is winded up on the roller 10 until it reaches the first side of the person 2's torso. Subsequently, the support sheet on the other side of the person 2's torso is winded up on the roller belonging to the support sheet of this side (as illustrated in FIG. 3).

FIG. 3 illustrates a further step in which a lifting frame 11 is positioned above the torso of the person. The figure illustrates the lifting frame as two frame parts each comprising a substantially horizontal bar. The two parts are connected through two side sections each extending from the frame parts and meeting in a flexible intersection 28. The flexible intersection allows the frame parts to be moved further apart or together. The bar endings are connected to vertical rods with connection means. The connection means allow each roller to be suspended between two corresponding vertical rods after the flexible intersection has been adjusted—if necessary—in order to position the rods in proximity of the roller ends.

At the suspension in between the rods the rollers are locked by the connection means ensuring that the support sheet cannot unwind the rollers unintentionally.

The frame also comprises a left and right supporting element engaging with the armpits of the person being lifted.

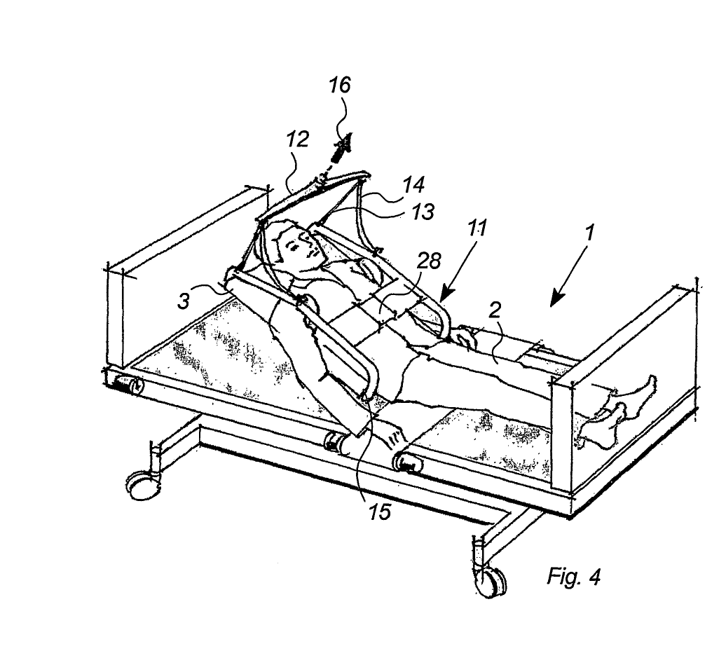

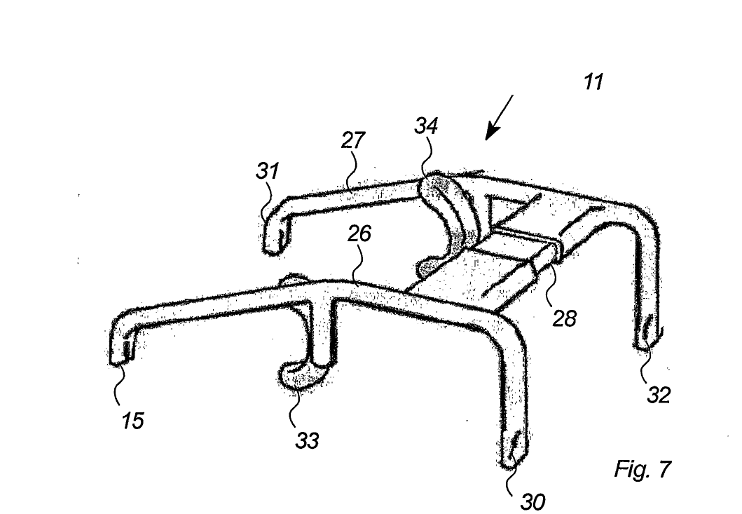

The frame construction will be further explained in connection with FIG. 7 and the functionality of the lifting frame will be apparent with the description of FIG. 4 to 6.

FIG. 4 illustrates the step of lifting the person to an up-right sitting position in the bed.

The lifting frame 11 is connected to the rollers holding the upper support sheet 3 e.g. a roller to the frame 11 in a connection point 15 between the roller 10 and the lower rod of the frame. Further, the support elements are positioned under the person's armpits. The person is hereby supported at the back and head by the upper support sheet 3 and at the torso by the frame 11 and the support elements.

The frame is further connected to a lifting yoke 12 through rear and front lifting lines 13, 14 in each side of the frame. The rear lifting lines 13 are connected to the top of the lifting frame 11 and the front lifting lines 14 are connected to a lower point on the lifting frame 11. At the middle of the yoke, the lifting yoke 12 is also connected to a yoke lifting line 16.

The yoke lifting line 16 is illustrated as being pulled by an external power in an upward angle forcing the yoke and the lifting frame with the upper support sheet up and forward. The person will also be raised towards a sitting position in the bed by the pull.

The sitting position will preferably be a position in which the person's body forms an angle of more than 90 degrees e.g. more than 90 degrees and less than 120 degrees. The angle can be obtained by the person's back being slightly leaned backward from an upright position or the legs slightly downward from a horizontal position (most hospital beds allow sections of the bed to be lowered). By placing the person in a slightly more than 90 degree position a more optimal lifting position for the person is obtained.

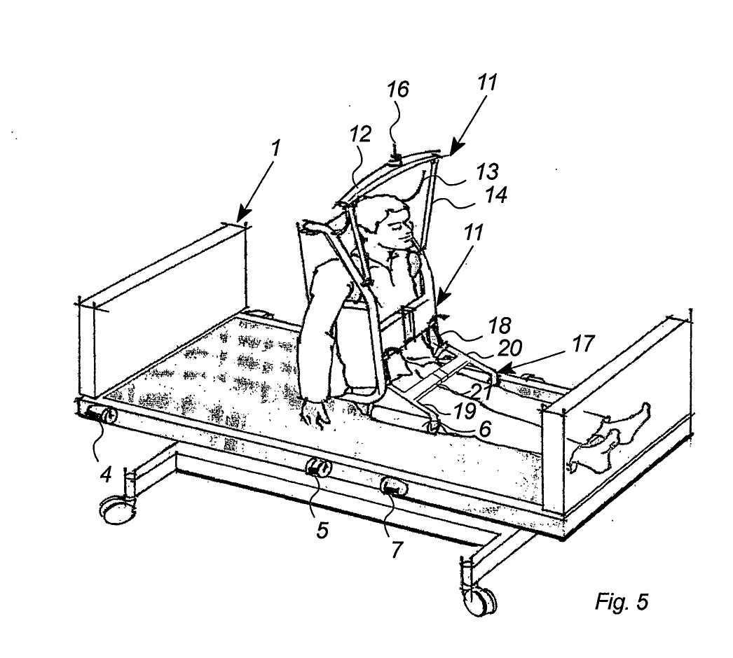

FIG. 5 illustrates the step of arranging a support frame 17 and a lower support sheet 6 under the seat or thighs of the person in a sitting position.

The lower support sheet 6 is winded up on the rollers until they reach the sides of the person 2's seat or thighs. After the seat or thighs are reached the flexible intersection 21 of the support frame is adjusted in order to extend over the thighs of the person and in such a way that two frame parts 19, 20 in the support frame meet the ends of the rollers. The rollers are hereafter connected to the two frame parts 19, 20 in the support frame. The connections between the rollers and the frame parts 19, 20 are established in the same manner as described above in relation with FIG. 3.

After the connection of the rollers and the frame parts each of the frame parts 19, 20 are attached to the frame parts of the lifting frame 11 by straps 18.

With the support frame 17 and the lower support sheet 6 connected to the lifting frame 11 the person is supported at the upper part of the body as well as the lower part.

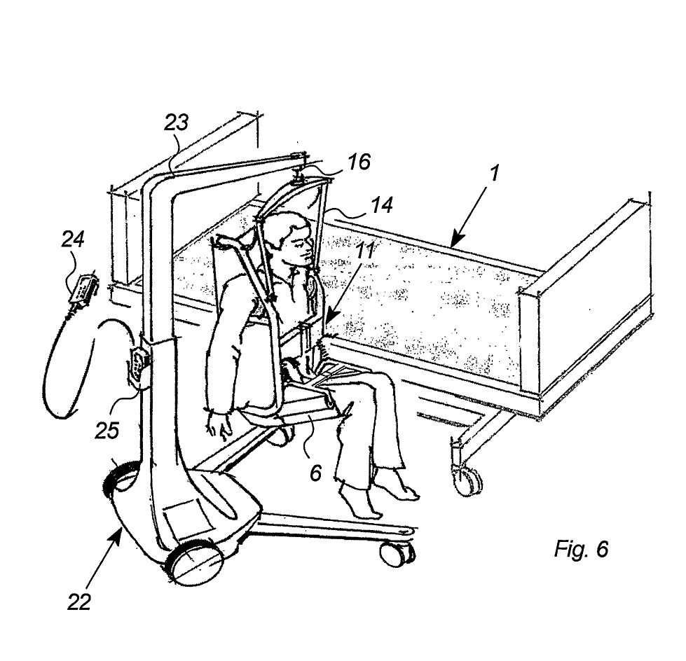

FIG. 6 illustrates the step of lifting the person in the handling system.

As the person is fully positioned in and supported by the handling system the person may be lifted up and away from the bed. The person is in the sitting position of the handling system under the full lifting process in which the functionality of the system is similar to that of an instructor's chair.

Preferably, the support sheet is positioned under the person's thighs—in an anterior part of the thighs—in such a way that is possible for the person to use the facilities of a bathroom without leaving the handling system.

The yoke lifting line 16 is connected to the lift arm 23 of a lift 22 such as standard lift. The lift comprises a remote control 24 positioned at the lift 22 in a remote control holder 25.

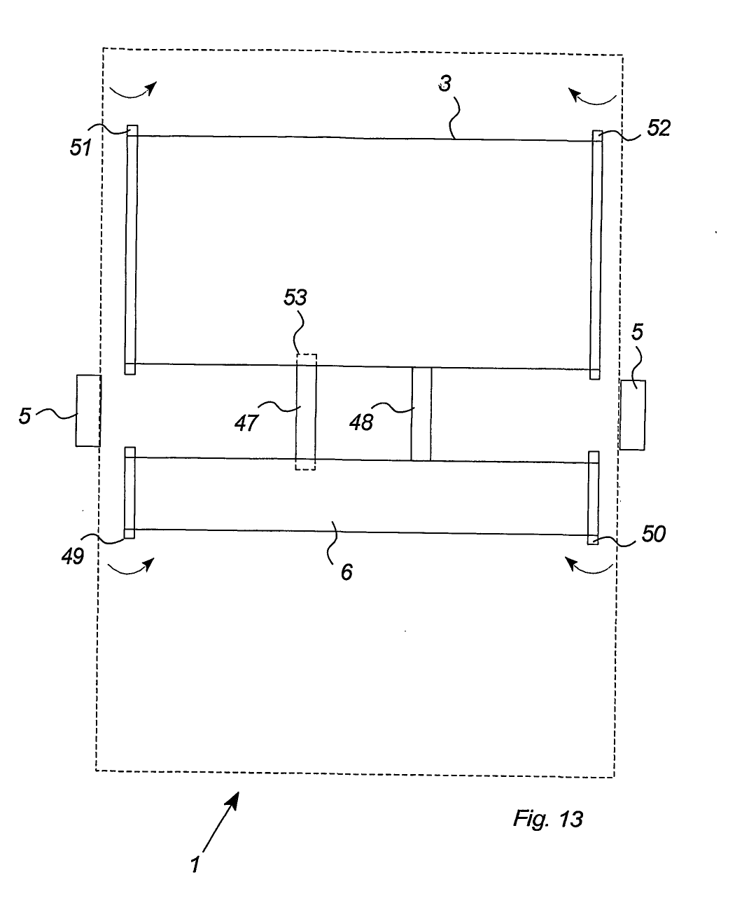

The remote control 24 may control the motors of the lift e.g. with the use of a wireless connection from the remote control to the lift control system. Further, the remote control may control the electric means in connection with the bed such as electric motors winding up or unwinding the support sheets on the rollers as explained in connection with FIG. 13.

It should be understood that the lift process of FIG. 1 to 6 may be reversed e.g. in order to lift a person from a chair to a bed with a handling system according to the invention.

FIG. 7 illustrates a preferred embodiment of the lifting frame 11.

The lifting frame 11 comprises a left and right frame part 26, 27 in which each part includes a bar comprising an upper and lower connection rod 29 to 32. The bar is slightly angled down in the direction of the upper part e.g. with an angle between 5 and 25 degrees.

The lower rods are perpendicular or substantially perpendicular connected to the end of the relevant bar. The upper rods are connected to the end of the relevant bar in a manner that makes them parallel with the lower rods. The rods all extend to positions being in the same physical plane.

The rods include locking means allowing a pair of matching upper and lower rods to engage and retain a roller carrying a support sheet.

Each of the frame parts also comprises a rod with a supporting element 33, 34 engaging with the person being lifted. The rod extends from the middle part of the bar e.g. substantially at the bend of the bar. The supporting element is illustrated as a curved cushion-coated furnishing that is attached to the frame part through the rod. Each of the supporting elements supports the person being lifted under and around the armpit.

Each of the frame parts also comprises a side section extending from the sides of the frame parts and toward each other. The side sections, and thus the frame parts, are joined by a flexible intersection 28, e.g. a telescopic intersection, allowing the frame parts to move further apart or together.

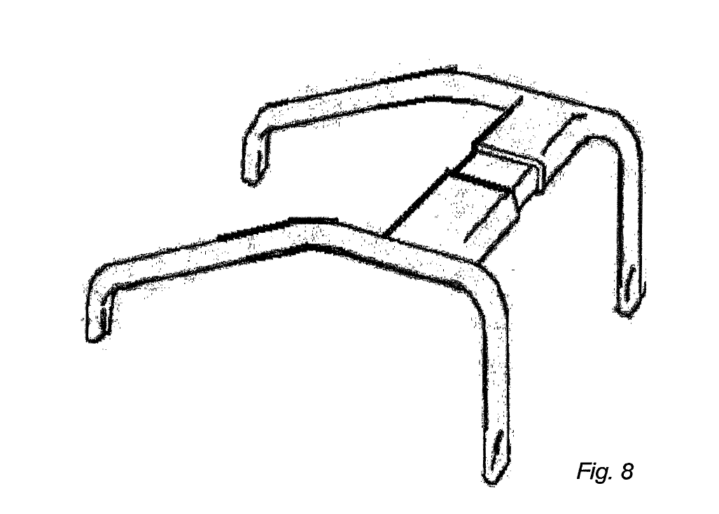

FIG. 8 illustrates a further preferred embodiment of the lifting frame used in connection with the handling system.

The embodiment involves no use of the above-mentioned supporting elements in the lifting frame 11 and thus no supporting of the person being lifted under and around the armpit.

The use of this lifting frame will be further described in connection with the embodiment of the support sheets illustrated in FIG. 13.

It shall be emphasised that the frames—lifting and/or support frames—may come in different sizes and forms. The key element of a frame is the possibility of connecting to a roller in both ends of the frame.

The form of a lifting frame is preferably such that it may be used in connection with most shapes of torsos e.g. the frame and especially the frame intersection being elevated at the region of the stomach and/or the breast. In a similar manner, the form of the support frame is adapted to the person being lifted e.g. by ensuring that the intersection is well above the thighs of the person during the lifting process regardless of the size of the thighs.

Further, the frames may have different sizes allowing the system to be used in connection with small as well as tall people e.g. children and adults.

In a preferred embodiment of the lifting frame—with or without supporting elements—the left and right frame part 26, 27 comprises a handgrip area e.g. a foam rubber covered area. Hereby, the person being lifted is encouraged to hold on to the frame and thus enhance the firm link between the handling system and the person. The person will feel more in control of the situation and at the same time injuries to the person's arms are less likely to take place as the arms are held close to the frame.

The lifting and support frames may be made in metal preferably aluminium but also steel, iron or other metals may be used. In some embodiments the frames may also be constructed—partly or totally—in plastic materials or similar lightweight materials. If a higher degree of strength than possible with plastic materials is required glass fibre materials or other fibrous enforced material such as coal fibre materials may be used.

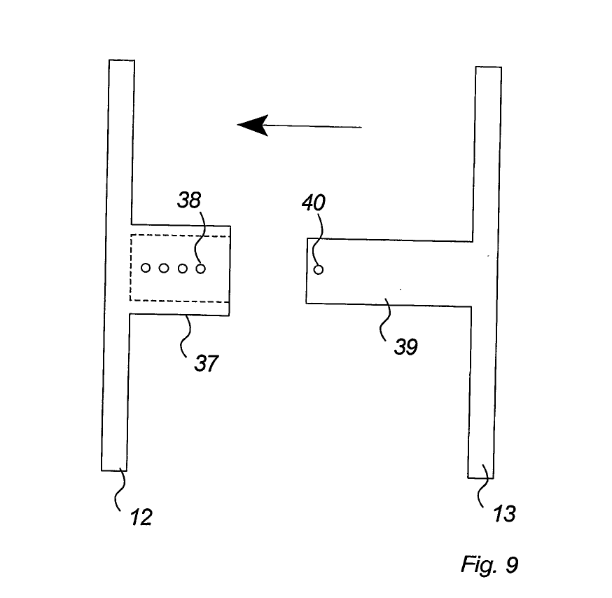

FIG. 9 illustrates an embodiment of a flexible intersection in the lifting and/or support frame.

The two frame parts 12, 13 comprise a female 37 and male intersection part 39. When the male part is positioned in the female part in a preferred position a pin may be positioned in the holes 38, 40 of the parts and thus locking the parts together. In order to establish a number of different positions the female part comprises a number of holes.

In a further embodiment the female part may include a snap lock that scrolls over the hole of the male part during positioning but retains the male part if the parts are tried to be separated.

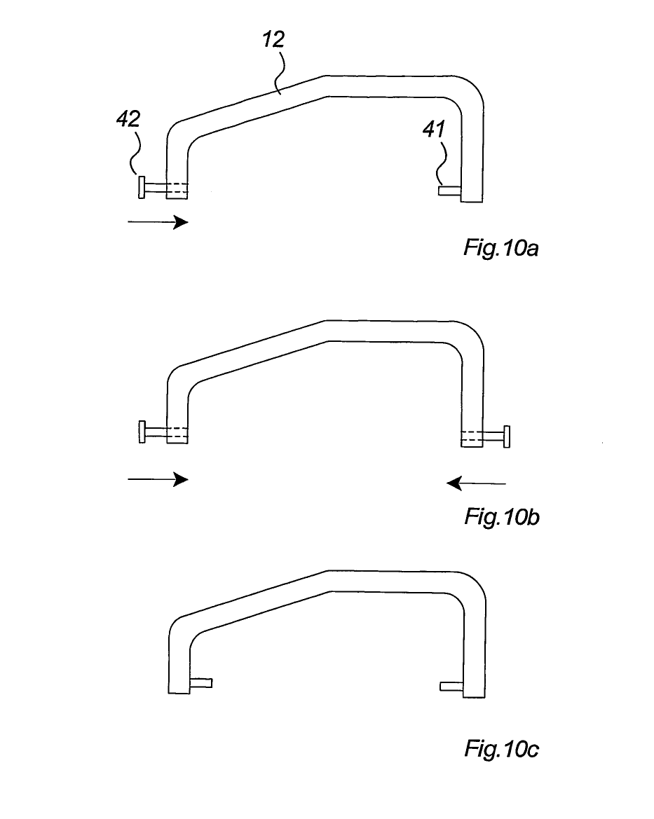

FIGS. 10a to 10c illustrate different embodiments of frame locking systems.

FIG. 10a illustrates a frame part 12—of a lifting or support frame—comprising a fixed extension 41 to the first frame rod. The fixed extension 41 expands substantially perpendicular to the rod.

Opposite the fixed extension 41 at the second rod a movable extension 42 is positioned. The movable extension 42 is illustrated as a piston that may be pushed in a direction toward the fixed extension through a hole in the rod and subsequently retracted again to the illustrated position.

By the combination of a fixed and movable extension 41, 42 it is possible to position a roller in between the extensions and with the movable extension lock the roller to the frame part 12.

FIG. 10b illustrates an embodiment in which both extensions are movable extensions. The flexibility of the roller locking is hereby enhanced.

FIG. 10c illustrates an embodiment in which both extensions are fixed extensions. This embodiment requires a flexibility of the frame part in a longitudinal direction in order to position the roller in between the rods.

It is important to emphasise that the fixed extension in its basic form only is fixed in the longitudinal direction. Both the extensions may be pivotally connected to the frame rods e.g. in such a way that a ratchet is created allowing the extensions to be turned in one direction but not the opposite. This creates the functionality that a support sheet can be winded onto the roller but cannot unwind the roller unintentionally. This functionality is especially advantageous in the eventuality that the roller needs to be closer to the person's body after the frame has been locked to the roller.

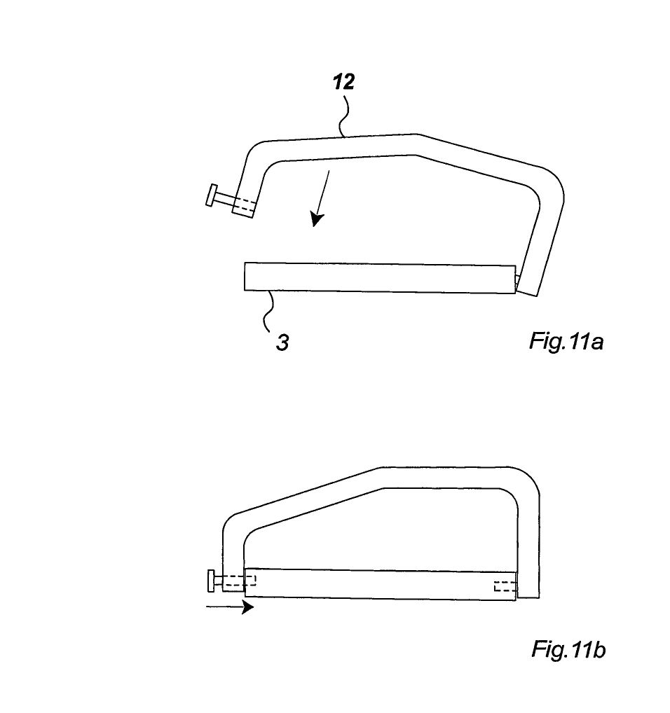

FIGS. 11a and 11b illustrate the method of locking a roller to a frame with the use of a locking system.

FIG. 11a illustrates the first method step; positioning of a fixed extension of the frame part in one roller end. The positioning is performed with the frame being slightly angled in relation to the roller in which the roller may e.g. be laying on a bed mattress in proximity of the person to be lifted.

FIG. 11b illustrates the final method step; after having moved the frame part down to the same level as the roller the movable extension is in the process of being forced into the other end of the roller and thus locking the frame part to the roller.

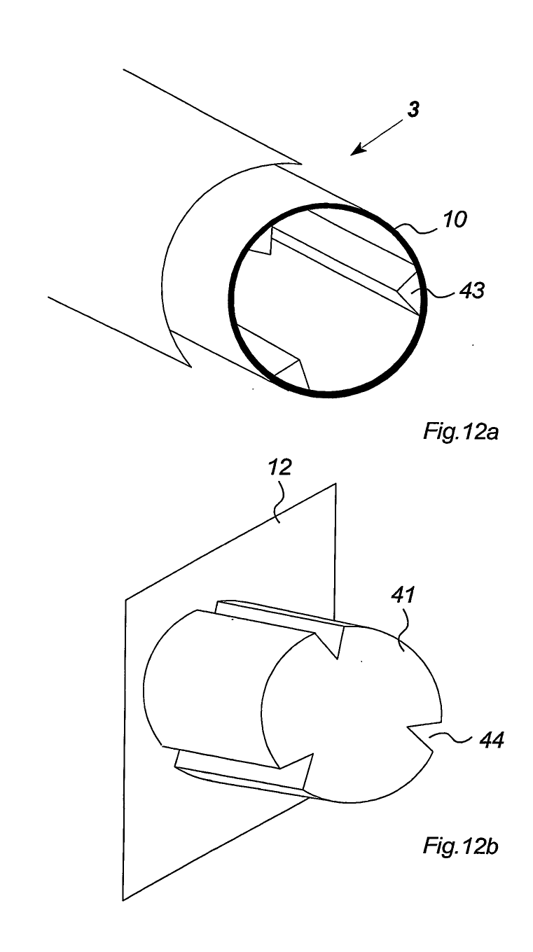

FIGS. 12a and 12b illustrate preferred embodiments of the roller and frame endings.

FIG. 12a illustrates the hollow end 10 of a roller together with a section of the sheet material 3. The internal surface of the roller comprises a number of longitudinal strengthening ribs 43 which extend in the full length of the roller.

FIG. 12b illustrates a fixed extension 41 extending from a frame rod 12. The fixed extension may comprise a number of notches 44, which correspond in number and shape to the longitudinal strengthening ribs 43 of the roller.

The internal surface of the roller may comprise any number of ribs e.g. more than ten ribs. The fixed and the movable extensions may comprise a triangular, square or a similar cross section that may engage a number of the notches created in between the ribs e.g. four notches engaged by a square cross section extension. Hereby, it is possible to create numerous different positions which the extensions may engage a roller.

The rollers may in a preferred embodiment be made in aluminium with a diameter between 15 and 50 millimetres such as 25 millimetres.

FIG. 13 illustrates an embodiment of the support sheets in which the upper 3 and lower support sheet 6 are connected by a first and second band 47, 48. One end of both bands is connected to the higher edge of the lower support sheet 6 preferably in a fixed manner. Further the connection is established close to the center of the of the support sheet in such a way that the bands are either underneath the person during use or in close proximity of the person.

The other end of the bands is connected to the upper support sheet in close proximity of the lower sheet edge e.g. with the use of a releasable connection 53 e.g. a Velcro connection or lock.

Further, the figure illustrates that the left and right roller 49, 50 for the lower support sheet are used in order to wind up the lower sheet support from opposite sides until the sides of the person (not illustrated) is reached.

The figure also illustrates that the left and right roller 51, 52 for the upper support sheet are used in order to wind up the upper sheet support from opposite sides until the sides of the person (not illustrated) is reached.

Even further, it is illustrates that the rollers 49-52 are moved or winded from the holding devices (illustrated in the figure only with the central holding device 5).

The support sheets may preferably be used in connection with the lifting frame of FIG. 8 with no armpit support. The person to be lifted is positioned with the upper part of the body on the upper support sheet and the lower part on the lower support sheet. The rollers 51, 52 are positioned in close proximity of the person's upper body and the lower rollers 49, 50 are positioned in close proximity of the person's lower body. The lifting frame is connected to the rollers 51, 52 and the lifting process is initiated by connecting a lifting yoke 12 and a lift to the lifting frame.

During the lifting of the person to a sitting position the weight of the person ensures that the lower support sheet stays in place. The bands 47, 48 connecting the sheets further ensure that the upper sheet and the lifting frame are kept from moving upwards until the sitting position is reached. After the sitting position is reached or after the lifting and support frames are connected the sheets may be disconnected by releasing the band ends at the upper support sheet, e.g. releasing the Velcro locks.

Another embodiment in connection with the use of lifting frame of FIG. 8 may involve straps between the two frames before lifting. After the sheets and rollers are positioned at the side of the person the frames are connected to the rollers. Hereafter straps are connected between the frames e.g. one strap connecting a lifting and supporting frame part.

During the lifting of the person to a sitting position the lifting frame is controlled by the straps but may move insignificantly upwards if they are not tighten throughout the process. After having reached the sitting position the straps are tighten to such an extent that the person may be lifted up and away from the bed (as illustrated in connection with FIG. 6).

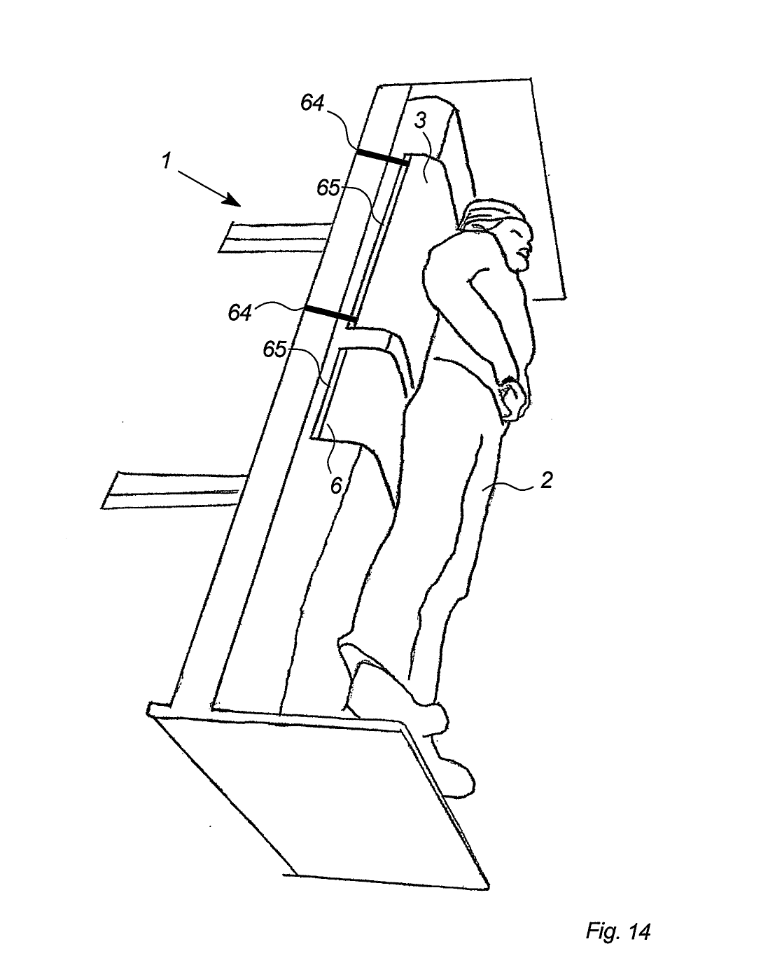

FIGS. 14 to 19 illustrate the functionality of a further embodiment of the handling system for lifting or moving a person from a first position to another.

The lifting 11 and support frames 17 of the previous embodiment correspond in functionality to the first 54 and second frame section 56, respectively.

FIG. 14 illustrates the person 2 positioned in a bed with the upper 3 and lower support sheet 6 stretched out on the bed mattress and underneath the person. The sheets stretch from one side of the bed to the other side in such a way that they pass under the back and head and under the seat or thighs of the person in the bed.

The sheets preferably stretch down the vertical sides of the mattress or the bed and are held in place by straps 64 connecting the sheets and the bed at the side of the bed.

The figure illustrates how two straps are attached at different positions on the bottom or the sides of the bed. The straps include Velcro means which allow the straps to connect to the sheets along the edges of the sheets e.g. at the corners of the sheets. The strap connection at the sheets may either be a direct connection between the Velcro means and the fabric of the sheets or an indirect connection in which the Velcro means connect to sections of Velcro receiving means 65 e.g. straps of Velcro fleece type connecting to sections of Velcro hook type or vice versa. The sections of Velcro receiving means 65 are positioned on the outer surface of the sheets e.g. by sewing or gluing the sections 65 at the edges of the sheets. The number of straps at the sides of the bed may be freely chosen. With a number of straps positioned close together down the sides of the bed, it will always be possible to find a strap to hold at the outer edge of a given sheet. However, each sheet only needs few, two or three, straps attached at the Velcro sections 65 of the longitudinal sheet edges in order to stay in place.

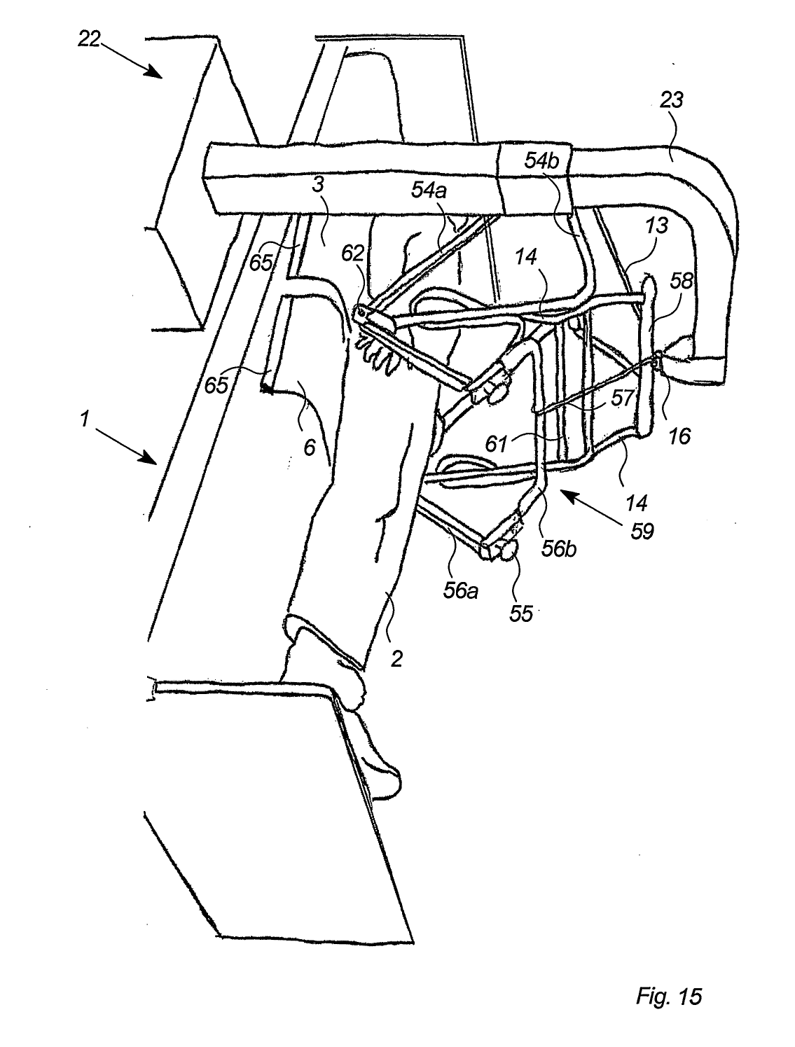

FIG. 15 illustrates the initial step in lifting the person from the bed with a lift 22. The person is laying stretched out in the bed with the arms close to the body. The lift 22 is positioned next to the bed 1. A lifting arm 23 of the lift 22 positions a handling frame 59 above the person and lowers the frame until it surrounds the person at the middle of the person 2. The freedom of operation of the arm 23 allows the handling frame to be lifted or lowered vertically or moved horizontally. The lift 22 and the arm 23 may also lift or move the person by being moved horizontally such as from a position at the upper part of a bed toward the lower part. The horizontal movement of the lift may be combined with a simultaneous lifting of the person by the lift.

The handling frame 59 comprises a first 54 and second frame section 56 which are connected with pivot hinges 62 at the sides.

The first frame section 54 is divided into a left and right side with intersections 61 connecting the sides. Each side is shaped substantially triangular with the rollers defining the base side. The triangular frame part 54b is connected to the roller 54a through a shaft (not illustrated) inside the roller. The shaft allows the roller 54a to rotate on the shaft and in relation to the triangular part 54b of the first frame section 54.

The triangular frame part 54b of the first frame section 54 may also comprise a shape as suggested in connection with FIGS. 10a to 11b or any similar shape that establish a frame structure at the arms of the person.

The intersections 61 are illustrated as two parallel bars connecting the sides around the vertex of their triangular frame part 54b of the first frame section 54.

The second frame section 56 comprises two rollers 56a which in one end extend from the hinges 62 and in the other are connected to a boom 56b interconnecting the rollers. The boom has a form allowing it to extend above the persons thighs preferably without touching them.

The hinge 62 allows the first 54 and second frame section 56 to pivot between different positions: In a first position, the first and second frame section 54, 56 form a V shape. A transport line 57 connected at each end to the two frames holds the sections together in the V shape. The first position is used during transport and storage as well as during the lowering of the handling frame until it surrounds the person to be lifted.

In a second position, the first and second frame section 54, 56 form a straight line with the mattress after the transport line 57 has been loosened or removed. The second position is used during the attaching of the sheets to the rollers of the handling frame and while the handling frame is resting on the mattress.

In a third position, the first and second frame section 54, 56 form a right or obtuse angle (from circa 90 degrees (handling with the person in an upright position) to circa 180 degrees (handling with the person in a stretched out position)) by tighten the front and rear lifting lines 13, 14. The third position is used during the lifting or moving of the person.

The sides of the handling frame 59 are connected to a yoke 58 with sets of front and rear lifting lines 13, 14. The yoke is connected to the lifting arm 23 in a pivot connection.

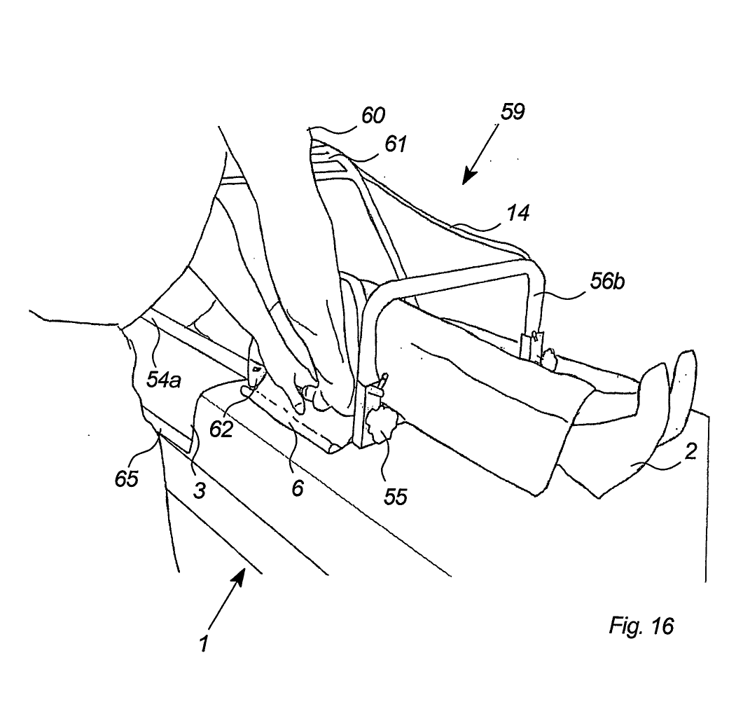

FIG. 16 illustrates the handling frame in the second position as described above.

The firm connections of the sheets to the rollers are in a preferred embodiment achieved by using Velcro sections positioned on the surface of the rollers 54a, 56a. The Velcro sections 65 at the edges of sheets are connected with the Velcro sections of the rollers. The Velcro connections are naturally locked by the support sheets 3, 6 subsequently rolled up on the rollers (and the Velcro connections). In another embodiment are used buttons/clips on the rollers which engage with reinforced non-circular openings in the support sheets. The buttons are subsequently turned to a locked position e.g. a 90 degrees turn.

The figure further illustrates how the assisting person 60 winds the lower support sheet 6 onto one of the rollers in the second frame section 56a (after having released the straps holding the sheets and establishing the Velcro connection between the sheet and the roller).

The winding is performed by turning the handle 55 which engages with the roller 56a through a gear connection. The gear connection establishes a transmission allowing the handle to be easily turned. Further, the gear connection includes a ratchet wheel and a spring operated pin that engages the wheel and only allows the roller to be rotated in one direction (until the pin is released).

Generally, the possible rotation direction of the handle will only allow wind up of the sheet and thus avoiding that the sheet is winded off the roller e.g. during the handling of a person.

The same procedure is subsequently performed at the other side of the lower support sheet 6 as well as on both sides of the upper support sheet 3 which are winded onto rollers 54a in the first frame section 54.

Poles (not illustrated) are fixed to the ends of the triangular frame part 54b. The poles go through the rollers 54a and with corresponding bearing means are the rollers capable of rotating around the poles e.g. by turning the connected handles 63. In similar manner are the boom 56b fixed to the pivot hinges 62 with further poles. The poles go through the rollers 56a and with corresponding bearing means are the rollers capable of rotating around the poles e.g. by turning the connected handles 55.

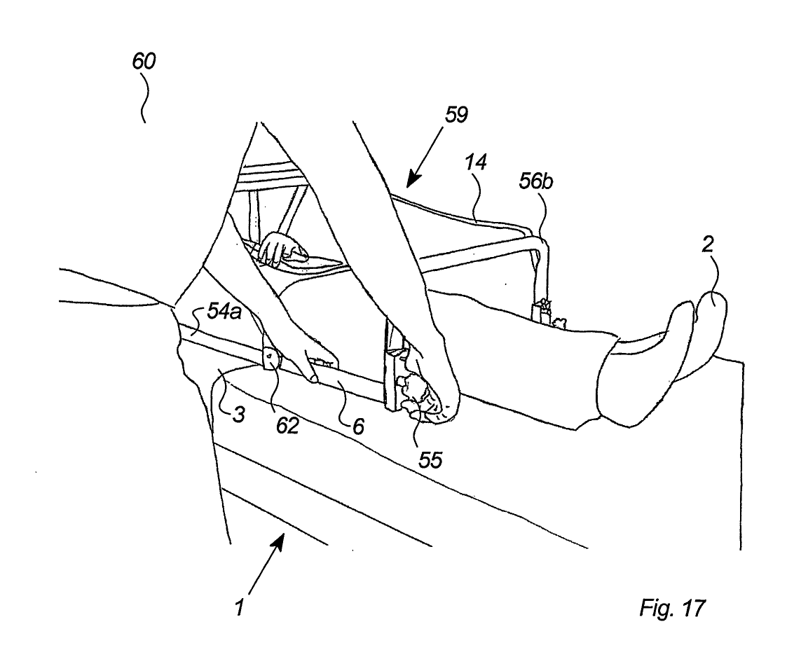

FIG. 17 also illustrates the second position of the handling frame 59 and especially the step in which any slack in the suspensions of the lower support sheet is removed by turning the handles 55. The handles 55 are connected to the respective rollers 56a and are as explained above used in winding or unwinding the support sheets.

The figure illustrates how the upper support sheet 3 still is stretched out on the mattress and thus awaits the winding process onto the roller 54a.

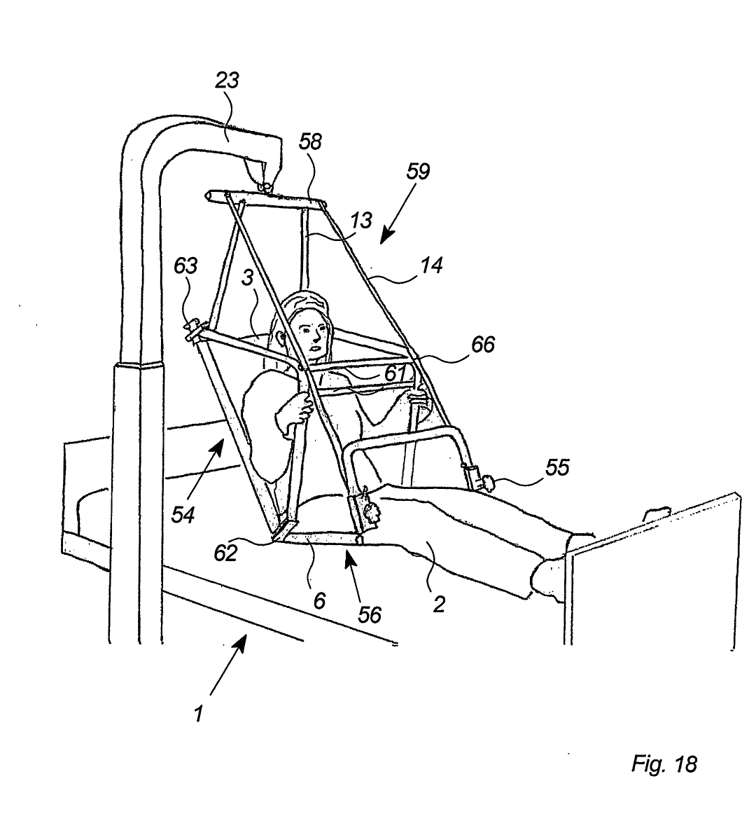

FIG. 18 illustrates the lifting and raising of the person to an upright position in the bed. The lifting arm 23 is used to lift the handling frame 59 through the yoke 58, which results in a tightening of the front and rear lifting lines 13, 14 and a pivoting movement in the hinge 62. The pivoting movement is continued until the frame sections 54, 56 and the rear and front lines 13, 14 are in balance e.g. with the person being in a sitting position on the bed 1.

The rear lifting lines 13 are connected to the rear of the first frame section 54 in proximity of the handles 63 and to the yoke 58.

In a first embodiment the first frame section comprises eyelets 66 in proximity of the vertex of the triangular shaped frame. Each of the front lines 14 goes through the eyelet from the yoke 58 to the second frame section 56. The movement of the front lines 14 may be restricted by obstacles (not illustrated), which are fixed to the lines above or below eyelets 66, and thus defines the maximal or minimal length between the first and second frame section. The front lines 14 are connected to the second frame section 56 at the boom 56b, in proximity of the handles 55.

In a further embodiment, the front lines 14 are firmly connected to the first frame section e.g. at vertex of the triangular frame part 54b. The front lines continue as separate lines from the triangular frame part 54b to the second frame section 56 in which they are connected to the frame at the one end of the rollers in proximity of the boom 56b and the handles 55. The continued front lines to the second frame section 56 is changeable in length e.g. by tightening the lines as the lifting arm 23 raises the handling frame 59. The front lines from the first to the second frame section may e.g. be straps and thus one of the sections comprises means for holding and securing the straps e.g. as they may be tightened. The angle between the first and second frame section 54, 56 may be varied with a pivot movement and thus establish a more or less stretched out position for the person or alternatively an upright position.

The lines may be connected to the frame sections 54, 56 in other positions than the above-mentioned but it is advantageously that the connection points of the rear and the front lines are spaced apart as much as possible e.g. by using the corners of the frame sections.

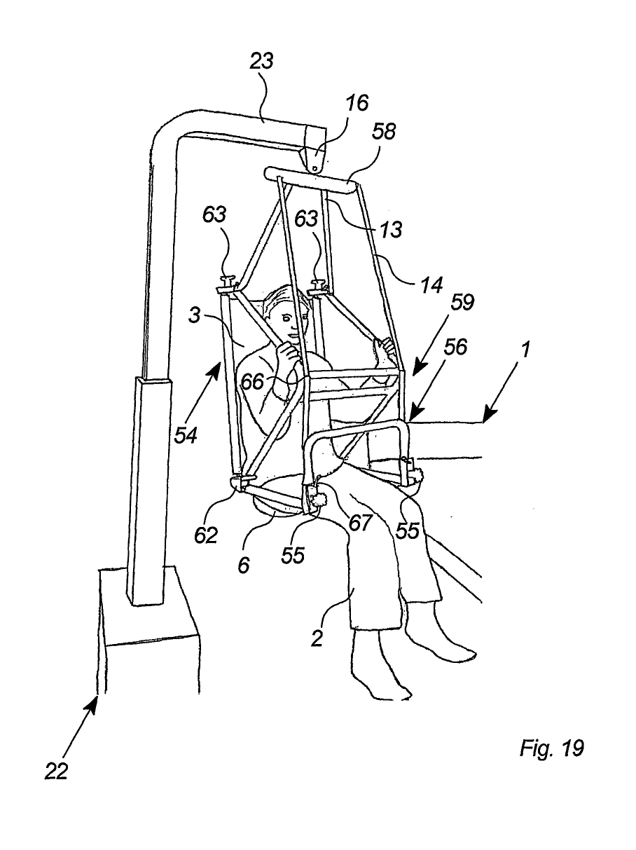

FIG. 19 illustrates the final step in lifting and moving the person from the bed. As the person is fully positioned in and supported by the handling system of the present embodiment the person may be lifted up and away from the bed. The person is in the sitting position of the handling system under the lifting process in which the functionality of the system is similar to that of an instructor's chair.

The lift 22 with the lift arm 23, in which the functionality of the lift corresponds to that of the lift illustrated in FIG. 6, performs the lifting of the person 2 from the bed 1. The lift may include electric or pneumatically driven motors e.g. motors in linear actuators.

The figure further illustrates the spring operated locking pins with handles 67 of the abovementioned gear connection. The handles may be moved to a locked position in which the pins are forced against the ratchet wheel and only allows the rollers 56a to be rotated in one direction. When the handles 67 are moved to a free position in which the pin is released from the wheel and the rollers may rotate freely.

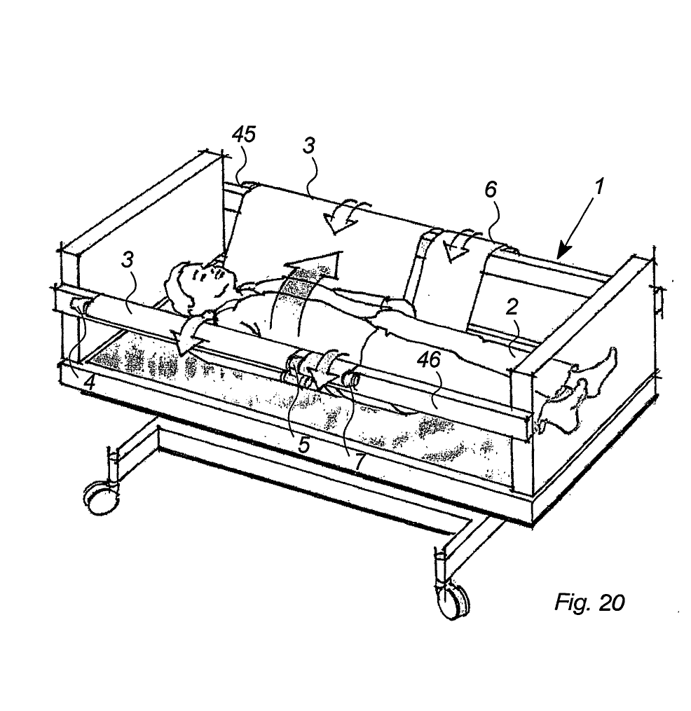

FIG. 20 illustrates an embodiment of the invention in which the handling system is used to move the person 2 in the bed 1.

The movement of the person 2 is accomplished by turning the rollers of the sheets in their holding devices 3, 5, 7 wherein the rollers of one side unwind while the others wind up. Hereby is created a sideway sheet flow that the person will follow either by moving with the sheet or by performing a rotating movement at the same position.

The type of movement is resolved by the angle of the roller performing the sheet winding up. The higher the rollers are positioned above the bed mattress the more rotating and less sideways movement will the person perform.

The figure illustrates the bed with a permanent left and right guide rail 45, 46 wherein the rails are elevated above the mattress. The rails include the necessary rollers as well as electric motor and control means in order to drive the rollers when they are winding and unwinding the sheets.

In a preferred embodiment the electric motor means comprise a gear motor in each side of the bed allowing small and precise movements. The motors have connections to the end of the rollers in their side of the bed. In the embodiment a motor drives the roller or rollers performing the wind up of the sheet while the other motor either unwinds or is turned off (and thereby allowing the unwinding of the sheet).

The control of the motors may either be performed by an assistant or by the person in the bed with the use of a remote control such as the remote control also used at the lifting of the person. Further, the control may be automated e.g. using a time schedule ensuring that the bedridden person does not get a pressure sore.

In the embodiment, the guide rails are not permanently fixed to the bed but may be placed in different positions elevated above or in level with the mattress. The different positions for the rails may e.g. be obtained by a number of furnishings on the side of the bed or by bolts through the rails into threaded holes in the bed. Hereby, it is possible to adapt the bed to a given situation such as a high position when rotating or moving the person sideways and a low position under normal or lifting situations.

In another embodiment, the upper and lower support sheets of FIG. 14 may be releasable attached to the rollers e.g. by using Velcro straps or sections. After the attaching of the sheets to the rollers, the rollers are used to winding and unwinding the sheets as described above e.g. by the aid of one or more electric motors.

Thus, the rollers are only connected to the sheets during the process of rotating the person but may be permanently mounted on the sides of the bed and preferably a little above the bed mattress. The rollers and the rotation system as such are thus always ready for use.

Further, the rollers may be part of a portable rotation system that is only positioned along and a little above the sides of the bed during use. The sheets used, e.g. in connection with persons that require frequent rotation, may be wider than the illustrated in FIG. 14 in order to enhance the rotation.

In a preferred embodiment the length for the support sheets is approx. 130 centimetres. The length for the rotation sheets is approx. 260 to 325 centimetres, equivalent to 2 to 2.5 times the length of the support sheets. The length of the sheets will of course depend on the width and thickness of the mattress.

The width/height of the upper support sheets 3 supporting the back corresponds to approx. 70 centimetres. The width/height of the lower support sheets 6 supporting the legs corresponds to approx. 30 centimetres. The width/height of the rotation sheets preferably corresponds to the support sheets.

The rotational movement may be performed before the lifting process is initiated in order to position the person favourably in relation to the handling system or in general to move the person with the aid of the handling system.

It will also be understood that the invention is not limited to the particular examples described above but may be designed in a multitude of varieties within the scope of the invention, as specified in the claims. Especially the different frames may be designed in a multitude of varieties such as being more rigid with further side sections. Further, the frames may be made in a number of materials such as steel, plastic or a composite material in order to achieve different functionalities e.g. strength, low cost or weight. Even further, the different details may be used in connection with other embodiments than the ones that they are described and illustrated with e.g. the upper and lower flexible intersections 28, 21 together with the upper and lower frame sections 54, 56.

An example may comprise the use of the lifting frame 11 and the upper support sheet 3, positioned around the person to be lifted, and connected with the lifting yoke 12 (as especially described in connection with FIGS. 3 and 4 and (partly) with FIGS. 17 and 18). Instead of lifting the person to an up-right sitting position from a laying down position, the lift is continued until the person is at a horizontal level equal to the up-right standing position for the person. In the up-right standing position the person may walk and at the same time being supported by the lift. Further, the person may push or drag the lift with him without aid from an assistant. In the embodiment of FIGS. 14 to 19 the second frame section 56 are used without a lower support sheet 6 and forced against the first frame section to a V shape as illustrated in FIG. 15 by using the transport line 57 or the continued front lines 14. Hereby, the walking person in the handling frame 59 may move the legs freely without hitting the boom 59.

Especially, the weight or strain on the person's body may be reduced e.g. if the person has a fractured leg or a similar disability, and at the same time the person is free to do different activities such as going to the bath room alone.

Further, the invention may be used in other situations than lifting persons from a bed e.g. by integrating the handling system in a chair or similar furniture.

Beside the lift 22 of FIGS. 6 and 19 any type of lifting mechanism may be used with the handling system e.g. a rail build into the ceiling above the person and the bed or chair.

### List

1. Bed
2. Person needing handling such as lifting or turning
3. Upper support sheet
4. Upper holding device
5. Central holding device
6. Lower support sheet
7. Lower holding device
8. Upper part of the person's body—above the waistline
9. Lower part of the person's body—below the waistline
10. Roller
11. Lifting frame
12. Lifting yoke
13. Rear lifting line
14. Front lifting line
15. Connection point between the roller and the lower connection rod of the left frame part
16. Yoke lifting line
17. Support frame
18. Connection straps
19. Left support frame part
20. Right support frame part
21. Lower flexible intersection
22. Lift
23. Lift arm
24. Remote control to control the lift
25. Holder for remote control
26. Left lifting frame part
27. Right lifting frame part
28. Upper flexible intersection
29. Upper connection rod of the left frame part
30. Lower connection rod of the left frame part
31. Upper connection rod of the right frame part
32. Lower connection rod of the right frame part
33. Left supporting element engaging with the person being lifted
34. Right supporting element engaging with the person being lifted
35. Left side section of the frame part
36. Right side section of the frame part
37. Female part
38. Holes in the female part
39. Male part
40. Hole in the male part
41. Fixed extension
42. Movable extension
43. Longitudinal strengthening ribs
44. Notch in the fixed extension
45. Left guide rail for the bed
46. Right guide rail for the bed
47. First band connecting the support sheets
48. Second band connecting the support sheets
49. Left roller for the lower support sheet
50. Right roller for the lower support sheet
51. Left roller for the upper support sheet
52. Right roller for the upper support sheet
53. Releasable connection such as a Velcro connection
54. First frame section for the upper support sheet
54a. Roller for the upper support sheet
54b. Triangular shaped frame part
55. Handle to wind or unwind the upper support sheet
56. Second frame section for the lower support sheet
56a. Roller for the lower support sheet
56b. Boom of the second frame section
57. Transport line connecting the first and second frame section
58. Yoke for the handling frame
59. Handling frame including the first and second frame section
60. Assisting person
61. Intersections between the right and left side of the first frame section
62. Pivot hinge between first and second frame section
63. Handle to wind or unwind the lower support sheet
64. Releasable strap connections such as a Velcro connection
65. Velcro strap at the sheet edge
66. Eyelet for the front lifting line
67. Spring operated locking pin with handle

1. Method of handling a person with a handling system including support means with at least two support sheets initially positioned under the person, said method comprising:
winding said at least two support sheets on at least four rollers to a position in proximity of the person's body,
connecting said at least four rollers to handling means, and
handling the person by performing a lift or movement in said support means by said handling means.

2. Method of handling a person according to claim 1 wherein said connecting includes a locking or fixing process of said at least four rollers to one or more frames and connecting said handling means to one or more of said frames.

3. Method of handling a person according to claim 2 wherein the handling of said one or more frames being performed by drive means, connected to said one or more frames through lifting lines and a lift yoke.

4. Method of handling a person according to claim 2 wherein the handling is performed with rear and front lifting lines connected to a yoke and extremity points of said one or more frames.

5. Method of handling a person according to claim 4 wherein said handling is performed as a vertical up or down movement or a horizontal movement of said lift yoke by said handling means.

6. Method of handling a person according to claim 1 wherein said at least four rollers being pivotally movable by handles or motor means.

7. Method of handling a person according to claim 6 wherein said pivotal movement is only possible in one direction during the winding of said at least two support sheets on said at least four rollers.

8. Method of handling a person according to claim 1 wherein said one or more support sheets, in a non-use situation, are suspended and stretched out on the mattress of the bed.

9. Method of handling a person according to claim 8 wherein said sheets are suspended by releasable straps or by said at least four rollers connected to holding means, said straps or said holding means being fixed to the sides of a bed.

10. Method of handling a person according to claim 1 wherein said at least two support sheets include an upper support sheet and a lower support sheet, being positioned under the upper and/or lower part of the person's body, respectively.

11. Method of handling a person according to claim 10 wherein handling is performed with only said upper support sheet and a corresponding frame.

12. Method of handling a person according to claim 1 wherein said handling movement is transferred to said at least two support sheets resulting in a movement of the person from a laying position to a position supported by said support sheets or vice versa.

13. Method of handling a person according to claim 1 wherein said support means are adapted to a size of the body in an area of the support sheets.

14. Method of handling a person according to claim 1 wherein a mutual distance between said at least two support sheets is controlled and/or upheld.

15. Method of handling a person according to claim 1 wherein said at least two support sheets are moved sideways underneath the person by dragging at one edge of each sheet and releasing at the other edge of each sheet.

16. Handling system for lifting or moving a person from a first position to another, said system comprising
support means, and
handling means,
wherein
said support means includes at least two support sheets in contact with different areas of the person's body during handling,
said support means further comprises at least four rollers for winding said at least two support sheets from opposite sides of the sheet to a position in close proximity of the person's body, said at least four rollers, and
said support means being connected to said handling means said rollers,
wherein said support means establishes a handling structure around the person allowing the person to be lifted or moved by activating said handling means.

17. Handling system according to claim 16 wherein said at least two support sheets include an upper support sheet and a lower support sheet, positioned under the upper and/or lower part of the person's body, respectively.

18. Handling system according to claim 16 wherein said support means further comprises a lifting frame or a first frame section connected to said upper support sheet through said at least two rollers and/or a support frame or a second frame section connected to the lower support sheet through said at least two rollers.

19. Handling system according to claim 18 wherein said lifting and support frame each includes a first and second frame part connected by at least one flexible intersection.

20. Handling system according to claim 18 wherein said lifting and support frames are connected by one or more straps from said lifting frame to each of said first and second frame part.

21. Handling system according to claim 16 wherein said upper and lower support sheets includes at least one flexible connection connecting opposite edges of the sheets.

22. Handling system according to claim 18 wherein said first and second frame section includes at least one connection, allowing said frame sections to perform a rotating movement in relation to each other.

23. Handling system according to claim 16 wherein said handling means comprises drive means, connected to said one or more frames sections through lifting lines and a lift yoke.

24. Handling system according to claim 16 wherein said first position is in a bed including said at least two support sheets and at least two holding devices for said at least four rollers or said at least two sheets.

25. Handling system according to claim 24 wherein said another position is sitting position.

26. Handling system according to claim 24 wherein at least two holding devices are fixed on the sides of the bed.

27. Handling system according to claim 16 wherein at least two holding devices are positioned on one or more movable guide rails.

28. Handling system according to claim 27 wherein said guide rails comprises drive means, connected to said at least four rollers allowing the rollers to rotate clockwise or anticlockwise to wind or unwind the upper and lower support sheets from the rollers.

29. Handling system according to claim 16 wherein said at least two support sheets includes a number of different types of lower support sheets comprising at least one of wider sheets for lifting and rotating a person, normal sheets for lifting the person and smaller sheets for lifting the person to the bath room, and a number of different types of upper support sheets.

30. Handling system according to claim 16 wherein said at least two support sheets includes a number of different types of upper and lower support sheets with different lengths for lifting a person and for rotating a person.

31. Handling system according to claim 30 wherein said upper and lower support sheets comprise connection sections at the longitudinal sheet edges.

32. Handling system according to claim 31 wherein said at least four rollers comprise connection sections on the roller surfaces.

33. Handling system according to claim 32 wherein said connection sections of said upper and lower support sheets and at least four rollers establish connections between said upper and lower support sheets and said at least four rollers.

34. Handling system according to claim 16 wherein said at least four rollers are connected to handles through gear means with teethed wheels allowing a transmission.

35. Handling system according to claim 34 wherein said gear means include at least one spring operated locking pin and at least one ratchet wheel allowing pivotal movement in only one direction during a winding of said at least two support sheets on said at least four rollers.

36. Handling system according to claim 18 wherein said lifting frame or said first frame section comprise triangular or similarly shaped frame parts with ends connected to two of said at least four rollers.

37. Handling system according to claim 16 wherein two of said at least four rollers are connected between ends at a pivot hinge and at a boom as a frame part.

38. Handling system according to claim 37 wherein said rollers are connected through poles fixed to said frame parts, said rollers rotating on said poles with bearing means.

39. Handling system according to claim 18 wherein the support means comprises rear and front lifting lines connected to a yoke and extremity points of said one or more frame sections.

40. Handling system according to claim 16 wherein said support means comprises adjustment means to adapt the size of the support means to a body of the person in an area of the support sheets by changing a width of the frames.
